(19) United States
(12) Patent Application Publication
(10) Pub. No.: US 2025/0245634 A1
(43) Pub. Date: Jul. 31, 2025

(54) MARKETPLACE IMPLEMENTATION FOR A PAYMENT MANAGEMENT SYSTEM

(71) Applicant: AMADEUS S.A.S., Biot (FR)

(72) Inventors: Mathieu LE MARIER, Geneva (CH); Angelina Petra BABIC, Madrid (ES); Damien ROMAND, Opio (FR); Cristina HONORATO VALDES, Madrid (ES); Giovanni PALA, Madrid (ES); Mahmoud BENHADDOU, Villeneuve-Loubet (FR); Colin SAVALLE, London (GB); Michael CALVARESI, Antibes (FR)

(21) Appl. No.: 19/022,856

(22) Filed: Jan. 15, 2025

(30) Foreign Application Priority Data
Jan. 26, 2024 (EP) 24305143.0

(51) Int. Cl. G06Q 20/08

(52) U.S. Cl. CPC G06Q 20/08

(57) ABSTRACT

Methods, systems, and computer program products for implementing a marketplace management process for a payment management system. A method may include providing, via a payment portal interface, access for a user device to a payment marketplace module. The method may further include receiving a provider search request from the user device via the payment portal interface. The method may further include determining, based on a partner matching algorithm and the at least one marketplace criterion, partner data associated with a plurality of partners. The method may further include updating the partner data based on at least one partner filtering criterion associated with a user of the user device. The method may further include providing the updated partner data for display at the user device via the payment portal interface.

### CROSS REFERENCE TO RELATED APPLICATION

This application claims priority from European Application No. 24305143.0, filed Jan. 26, 2024, which is also incorporated herein by reference in its entirety.

### TECHNICAL FIELD

The present invention generally relates to computers and computer software, and more specifically, to methods, systems, and computer program products for implementing procedures associated with a payment management system.

### BACKGROUND

In order for a travel provider to be able to handle moving towards a more standard retail industry approach utilizing the latest fintech innovations and for integrating multiple payment methods from different software systems, a travel provider needs to ensure that their frontend systems and customer graphical user interface (GUI) touchpoints maintain synergies between the sales channels (e.g., the New Distribution Capability (NDC) context such as passenger name record (PNR) systems, online centers, call centers, operations, etc.) and the payment context. Merchants need to integrate the various software systems and services individually on their touchpoints in order to accept payments. For example, the airline industry may desire to offer payment scope (e.g., credit cards, digital payment vehicles, fraud check, and the like) on all the airline merchants digital touchpoints (e.g., booking, check-in, etc.). Airlines will need to integrate each of the different software systems on their website. This leads to an increase in cost for an airline, longer time to market, and increase in complexity. Additionally, a payment operation related to a PNR may require additional verifications on the back-end servers. For example, reward payments such as using miles with cash payments, fee calculations, etc., will require different verifications on payment side. Moreover, the airline industry will also need to maintain their PNR integration and payment orchestration logic on backend side to match with the payment software systems integrated on their frontends.

In some conventional reservation systems, payment information is provided in a manner such that the payment information cannot be authenticated. For example, a travel customer may communicate with a travel agent using telephone communication, and the travel customer may provide the travel agent payment information verbally. In this example, the travel agent enters the payment information at a reservation device, such as a computer, and the payment information is not verified/authenticated. As another example, if a travel customer books travel with a travel agent in person, unless the travel agency is equipped with electronic payment capture devices (i.e., credit card readers, etc.), the payment information (e.g., a credit card number) may still be fraudulent. As such, for these conventional payment channels for travel reservations, the payments submitted through such channels may be considered unsecure.

In general, unsecured payments increase costs for travel merchants (e.g., airlines, rail travel providers, hotels, etc.), travel booking systems (e.g., global distribution systems), and/or third-party reservation services (e.g., travel agencies), as liability for fraudulent payments through unsecured payment channels typically remains with the travel merchant, travel booking system, and/or third-party reservation service. In addition, because the travel merchant, booking system, and/or third-party reservation service handle the payment information for such unsecured payment channels, the travel merchant, booking system, and/or third-party reservation service may be required to comply with various security standards for sensitive payment information. For example, the travel merchant, booking system, and/or third-party reservation service may be required to comply with the Payment Card Industry Data Security Standard (PCI DSS), which is an information security standard for organizations that handle cardholder information for many debit, credit, prepaid, e-purse, ATM, and point of sale (POS) payment cards. Complying with such standards typically increases costs associated with processing payments for travel reservations.

Moreover, many travel merchants and reservation systems utilize a travel agency selling model, i.e., travel agencies distribute a travel merchant's products on behalf of the travel merchant. However, the travel merchant generally is liable for the payment, even in the case of fraudulent payments. Therefore, in conventional systems utilizing the travel agency selling model, travel merchants are generally dependent on travel agency procedures to secure payments.

Whenever travel merchants and reservation systems accept payment, they need to be sure that the data is consistent and that they are able to provide all necessary information (e.g., the code, etc.) that they might require for the eventual accounting reconciliation purpose. For example, the travel merchants need to ensure that data is available for their back office and have the capability to maintain an integration of payment data inside their booking system. Furthermore, processing a payment is not a straightforward operation, specifically in the travel industry. Before performing the payment processing, several operations may be needed to make sure that an authorized amount is correct. For example, before payment is processed, there may be a need to update of the amounts in the pricing records in case the payment instruments selected modify the price of the product to be purchased. Additionally, the pricing records themselves may need to be updated in case the marketplace request does not match the current state of the PNR (partial payment). Verification of the Bank Identification Number (BIN) number may be needed in case of a credit card (CC) payment, or acquiring the correct vendor based on the BIN. Further, during payment processing, an authorization request may need to be sent with the correct amounts computed from the PNR.

A payment management system provides a payment ecosystem that connects travel companies to the latest travel fintech innovations with an aim to improve the payment experience for travelers. However, the payment platform customers do not have visibility on the payment partners that are already integrated on the platform and it may be difficult to have new partners quickly integrated and made available to cover their different needs. For example, some of the needs of customer is to better serve their own customers (travelers) by giving them the ability to use their local form of payment (FOP), benefit from payment industry innovative new capabilities (e.g., Buy Now Pay Later), and comply with the multiple different global regulations (e.g., new provider to be connected in some countries where payment needs to be locally processed, data storage, etc.). For example, customers want to be able to pay in their local form of payment and chose from providers/partners that support that. Additionally, the payment partners want to be more visible to all payment platform customers (e.g., to gain new customer and increase volumes). Thus, improved methods, systems, and computer program products for providing improved management systems for travel bookings that provide visibility of the payment partners and scale partner integration are needed.

### SUMMARY

In embodiments of the invention, a method for implementing a marketplace management process for a payment management system is provided. The method, at a device including one or more processors, includes providing, via a payment portal interface, access for a user device to a payment marketplace module. The method further includes receiving a provider search request from the user device via the payment portal interface, where the provider search request includes at least one marketplace criterion. The method further includes in response to receiving the provider search request. The method further includes determining, based on a partner matching algorithm and the at least one marketplace criterion, partner data associated with a plurality of partners. The method further includes updating the partner data based on at least one partner filtering criterion associated with a user of the user device. The method further includes providing the updated partner data for display at the user device via the payment portal interface.

These and other embodiments can each optionally include one or more of the following features.

In some embodiments of the invention, the at least one marketplace criterion includes markets, currencies, products, product capabilities, live traffic, or a combination thereof. In some embodiments of the invention, determining the partner data associated with the plurality of partners based on the partner matching algorithm and the at least one marketplace criterion includes determining markets, currencies, products, product capabilities, live traffic, or a combination thereof, associated with the plurality of partners.

In some embodiments of the invention, the at least one partner filtering criterion associated with the user of the user device includes contract agreement data that includes a location, a region, a type of product, or a combination thereof.

In some embodiments of the invention, updating the partner data includes rearranging an order of the plurality of partners based on the contract agreement data. In some embodiments of the invention, providing the updated partner data for display at the user device includes displaying the rearranged order of the plurality of partners based on the contract agreement data.

In some embodiments of the invention, the provider search request includes a live traffic transaction option that is selected via the payment portal interface at the user device. In some embodiments of the invention, the partner data is updated by utilizing live traffic data from a live traffic database based on the selection of the live traffic transaction option.

In some embodiments of the invention, the method further includes receiving, at the payment portal interface, an update request from the user to modify one or more portal elements associated with the user, and updating the one or more portal elements based on the update request. In some embodiments of the invention, the one or more portal elements are based on profile information, push notification options, subscriber features, ranking score structures, live traffic transaction options, or a combination thereof.

In some embodiments of the invention, the payment portal interface includes a front-end application program interface (API). In some embodiments of the invention, the API is based on a representational state transfer protocol. In some embodiments of the invention, the provider search request is received from a travel provider server.

In some embodiments of the invention, a device including a non-transitory computer-readable storage medium, and one or more processors coupled to the non-transitory computer-readable storage medium, wherein the non-transitory computer-readable storage medium includes program instructions that, when executed by the one or more processors, cause the one or more processors to perform the method as described above.

In some embodiments of the invention, a computing apparatus including one or more processors, at least one memory device coupled with the one or more processors, and a data communications interface operably associated with the one or more processors, where the memory device contains a plurality of program instructions that, when executed by the one or more processors, cause the computing apparatus to perform the method as described above.

In some embodiments of the invention, a non-transitory computer storage medium encoded with a computer program is provided, where the computer program includes a plurality of program instructions that when executed by one or more processors cause the one or more processors to perform the method as described above.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 illustrates an example environment for implementing a payment marketplace process and a partner self-onboarding integration process, according to embodiments of the invention.

FIG. 2A illustrates an example of a marketplace search process based on a marketplace search request, according to embodiments of the invention.

FIG. 2B illustrates an example of a marketplace process based on a marketplace notification request, according to embodiments of the invention.

FIGS. 3-10 illustrate example screenshots for optimization of availability determination processes via an availability user interface, according to embodiments of the invention.

FIG. 11 is a flowchart of an example process for implementing a payment marketplace process, according to embodiments of the invention.

FIG. 12 illustrates an example of a partner self-onboarding integration process based on an onboarding request, according to embodiments of the invention.

FIG. 13 illustrates an example timeline overview diagram of a partner self-onboarding integration process based on a contract agreement, according to embodiments of the invention.

FIG. 14 illustrates an example of a partner self-onboarding integration process based on a contract agreement, according to embodiments of the invention.

FIG. 15 is a flowchart of an example process for implementing a partner self-onboarding integration process, according to embodiments of the invention.

FIG. 16 is a block diagram showing an example computer architecture for a computer capable of executing the software components described herein, according to embodiments described herein.

### DETAILED DESCRIPTION

The technology in this patent application is related to systems and methods for implementing a framework for a two-sided platform which enables to put into relation customers and providers (e.g., a “marketplace”) and a framework in the marketplace to scale partner integration (also referred to as “self-onboarding”). The framework may include a Representational State Transfer application program interface, i.e., a “REST API” process payment service (e.g., RESTful API is an architectural style for an application program interface (API) that uses HTTP requests to access and use data). For example, on one side the providers integrate a REST API, get connected, get certified and can access its profile, complete their listing, and eventually check performance data. On another side, the customer get visibility on products and capabilities available.

The payment marketplace process and the partner self-onboarding integration process utilizes one or more payment platform servers that are in communication with the travel providers, travel reservation systems, and payment processors via a payment platform gateway.

One of the important advantages for this system is to be able to change a provider to another provider without any impact on the customer side. In some implementations, a customer may need to sign with a new provider and then update then the configuration, but there is no integration effort that is needed. In some implementations, once integrated on the marketplace, there may not be a need to sign a new contract, insert specific new credentials (e.g., configuration set up linked to the communication with the new provider), adapt to any file from the new provider system, and/or change anything except the provider's configuration selection.

The payment marketplace process integrates a plurality of payment services and thus require a complex orchestration aspect. The payment marketplace service provides detailed information based on live traffic, an ability to differentiate and expose live traffic but also other information and can restrict information being displayed and capabilities based on current contract requirements. For example, based on contract requirements a partner may chose to declare product and capabilities that they support in addition to the live traffic (e.g., basically to do marketing on what “else” they do, that they do not have within the payment platform currently).

In an exemplary embodiment, the marketplace process is based on the following steps. First, users (e.g., customers) log into and access a marketplace module on the payment management platform via a payment portal. Users can then search for providers based on a series of different criteria: markets, currencies, products, product capabilities, and the like. The payment management platform retrieves the partners matching the criteria used. For example, for static criteria, the payment marketplace process may leverage live traffic information such as transaction volume, acceptance rate, or response time to rank the results in order to propose best matches first for given customer's profile. From a provider's side, the payment platform may highlight some of the results based on a subscription level (e.g., a premium “sponsored” link first). For example, if the customer searching for a payment provider is a hotel customer, the payment marketplace process may rank the results to display the providers that are most relevant for the hotel industry first based on the searched criteria discussed herein, e.g., volume, acceptance rate, etc.).

In an exemplary embodiment, the marketplace process continues and the payment management platform then displays the information based on marketplace packages contract agreements. Depending on the information associated with a contract agreement, a partner may be able to access an associated profile and update information (which may then be flagged accordingly), manage push notifications to customers, be available for customers to subscribe to their updates, and be preferably ranked in customers searches.

The self-onboarding integration process integrates a plurality of payment services and thus require a complex orchestration aspect in order to provide a complete end-to-end, self-service process flow to get connected to payment management platform. In an exemplary embodiment, the onboarding process is based on one or more of the following steps. First, users (e.g., partners) access an interface to subscribe to the platform offers, fill products they will power via the partnership, and the like. Then, based on the data filled by the user, the payment management platform may generate different tools for the user to get connected to the payment management platform (e.g., API, scripts, network, etc.). The payment management platform allows the user to provide development on the user side following a defined workflow to integrate with the payment management platform. Then the payment management platform may display the newly integrated certified partner under the marketplace module on the payment management platform via a payment portal (e.g., the certified partner and its capabilities will then be exposed to customers, so that they can make a conscious decision about whether to contract with this partner or not).

More specifically, this technology includes a marketplace process that may provide, via a payment portal interface (e.g., a front-end API, such as a payment portal), access for a user device (e.g., travel provider system) to a payment marketplace module. The process may further include receiving a provider search request from the user device via the payment portal interface, wherein the provider search request includes at least one marketplace criterion (e.g., customers can then search to look for providers based on a series of different criteria such as markets, currencies, products, product capabilities, and the like). The process may further include, in response to receiving the provider search request, determining, based on a partner matching algorithm and the at least one marketplace criterion, partner data (e.g., markets, currencies, products, product capabilities, etc.) associated with a plurality of partners (e.g., payment providers). The process may further include updating the partner data based on at least one partner filtering criterion associated with a user of the user device. For example, the partner data may be updated based on contract agreements, where the goal is to first display partners based on a location such as a region, or a type of product, or display partners relevant for the segment the customer is operating within (e.g., hotel industry). The process may further include providing the updated partner data for display at the user device via the payment portal interface. For example, the system displays the information based on marketplace packages contract agreements. Depending on the details to a particular contract agreement, a partner may be able to access an associated profile and update information (which may then be flagged accordingly), manage push notifications to customers, be available for customers to subscribe to their updates, and be preferably ranked in customers searches.

Additionally, this technology includes an onboarding process that provides, via a payment portal interface (e.g., a front-end API, such as a payment portal), access for a partner device (e.g., payment providers) to an on-boarding integration module. The process may further include receiving partner data from the partner device via the payment portal interface, wherein the partner data includes at least one of a platform offer or a payment product corresponding to a partner associated with the partner device. For example, users (e.g., marketplace partners) may access an interface to subscribe to the marketplace platform offers and/or fill products they will power via the partnership (e.g., markets, currencies, products, product capabilities, etc.). The process may further include, in response to receiving the partner data, determining, based on a payment management platform algorithm, at least one payment management interface tool associated with the partner, wherein the at least one payment management interface tool includes user integration instructions. For example, based on the data filled by the marketplace partner, the payment management platform may generate different tools for the user to get connected to the payment management platform (e.g., REST API, scripts, network, test use cases, personalized documentation, tools related to API documentation, network connectivity, and the like. The process may further include receiving an integration request from the partner device via the payment portal interface. The integration request may include integration data entered via the partner device and based on a defined workflow integration environment corresponding to the user integration instructions (e.g., after provider implements/integrates REST API services, payment management platform allows the user to provide development on the user side following a defined workflow to integrate with the payment management platform). The process may further include providing, based on the integration data, the partner data for display at a user device via the payment portal interface. For example, the payment management platform may display the newly integrated certified partner under the marketplace module on the payment management platform via a payment portal.

In the exemplary embodiments discussed herein for the payment marketplace process and a partner self-onboarding integration process via a payment platform, the referenced embodiments generally refer to the travel sector. However, the payment marketplace and the partner self-onboarding integration processes discussed herein may apply to any global system that provides worldwide payments. For example, the process may apply to any entity that desires to know what are the already connected and used payment partners, and with the functionality of the data being enriched with live traffic coming from current and/or potential customers.

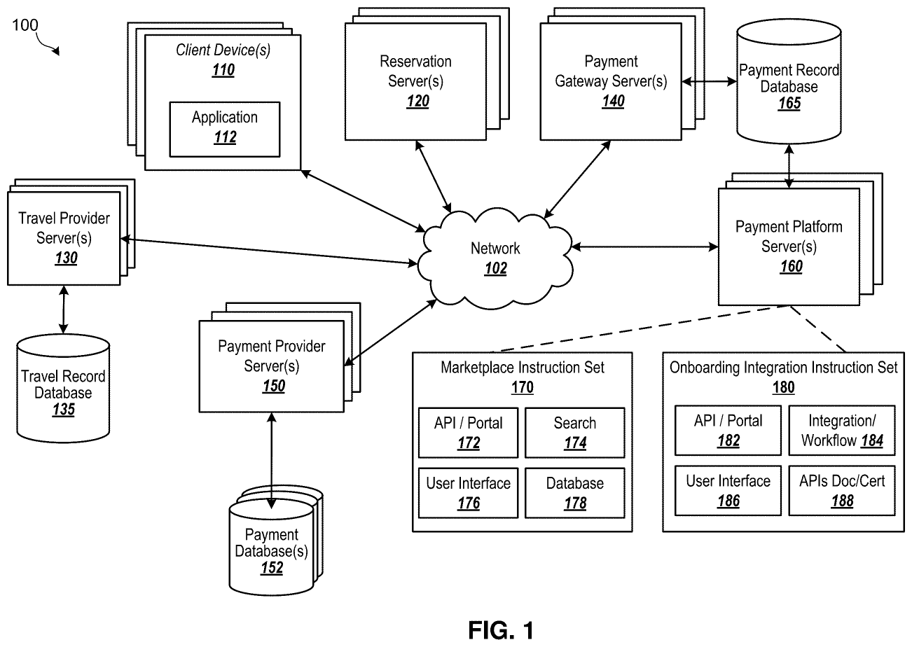

FIG. 1 is an example operating environment 100 for implementing a payment marketplace process and a partner self-onboarding integration process, according to embodiments of the invention. The example operating environment 100 includes one or more client device(s) 110, one or more reservation server(s) 120, one or more travel provider server(s) 130, one or more payment gateway server(s) 140, one or more payment provider server(s) 150, and one or more payment platform server(s) 160, that communicate over a data communication network 102, e.g., a local area network (LAN), a wide area network (WAN), the Internet, a mobile network, or a combination thereof.

The one or more client device(s) 110 (e.g., a device used by a user, i.e., a client/customer executing a travel booking) can include a desktop, a laptop, a server, or a mobile device, such as a smartphone, tablet computer, wearable device (e.g., smartwatch), in-car computing device, and/or other types of mobile devices. Additionally, the one or more client device(s) 110 may be public uses devices such as a kiosk, a user terminal, and the like. The one or more client device(s) 110 includes applications, such as the application 112, for managing marketplace and/or onboarding requests to/from any of the entities associated with the servers 120, 130, 140, 150, and 160 associated with the payment marketplace process and/or the partner self-onboarding integration process disclosed herein. The one or more client device(s) 110 can include other applications. The one or more client device(s) 110 may initiate a marketplace search request, a marketplace notification request, an onboarding request, or execute a selected marketplace for payment processing via application 112. The one or more client device(s) 110 may be utilized by a client to visualize a partner marketplace based on live traffic data via a payment portal interface or initiate a self-onboarding process (e.g., a client developer).

The one or more reservation server(s) 120 manages reservation booking requests between users (e.g., travelers) and travel providers. The one or more travel reservation server(s) 120 may be a personal computing device, tablet computer, thin client terminal, smart phone and/or other such computing device. The one or more travel reservation server(s) 120 receive booking data from a user device to reserve a travel reservation and generate a PNR for that particular travel product(s) associated with the booking data. Although a PNR is described as being generated, which is in regard to an example of an airline booking, the systems described herein could further include any other type of order management system for other travel providers, such as hotels, rental cars, etc., capable of generating a record associated with booking data. As such, in general, a reservation application executes on a reservation device (e.g., application 112 on client device 110) to generate a front-end through which a travel agent may interface with the reservation server 120 to reserve a travel booking for a travel customer. For example, a reservation device executing a reservation application may operate as a remote terminal connected to reservation server 120, and a travel agent may reserve a travel booking for a travel customer by interfacing with the reservation server 120. Additionally, after a consumer confirms an issuance for the particular travel product(s) associated with the booking data, a reservation server 120 initiates a payment process by sending an order request to the one or more travel provider server(s) 130 associated with the requested travel product(s) from the consumer.

The one or more travel provider server(s) 130 (e.g., travel merchants) generally include airlines, rail travel providers, hotels, and/or other such merchants that offer travel or travel-related services to customers. The one or more travel provider server(s) 130 generally facilitate remote communication therewith to reserve travel or travel-related service from a particular travel merchant. After a consumer confirms an issuance for the particular travel product(s) associated with the booking data, a travel provider server 130 receives an order request from a reservation server 120 and initiates a payment process by requesting payment from a user device. After receiving a payment confirmation for a particular travel booking, a travel provider server 130 may request and receive a travel record ID from the reservation server 120 and send booking confirmation to the user device via the reservation server 120. Additionally, the one or more travel provider server(s) 130 are configured to initiate a marketplace orchestration process after receiving a payment confirmation from the one or more APS server(s) 150 via the one or more payment gateway server(s) 140 and sending booking confirmation data by sending a marketplace request to the one or more payment platform server(s) 160.

The one or more travel provider server(s) 130 may be front-end server(s) for managing, collecting, processing, and communicating travel records (e.g., travel booking requests, resource information, revenues management data, bookings data, airlines/system configurations data, etc.), that is stored in the travel record database 135. Further, the one or more travel provider server(s) 130 may be front-end server(s) for managing, collecting, processing, and communicating payment requests and marketplace orchestration data from one or more payment platform server(s) 160 to the one or more reservation server(s) 120.

The one or more payment gateway server(s) 140 manages the payment transactions of travel booking requests received from application 112 between the one or more client devices 110 and the APS server(s) 150. The management protocols of the one or more payment gateway server(s) 140 may be based on a redundant load-balancing system by managing multiple clients (e.g., client device(s) 110) so that a payment associated with a travel booking request is handled by one of the one or more APS server(s) 150. For example, there may be multiple APS server(s) 150 that are able to service the travel booking payment, and the redundant load-balancing system of the payment gateway server(s) 140 is responsible for ensuring that the travel booking request is performed by one of the capable APS server(s) 150. Payment processors include for example, a credit/debit card issuer, a bank, digital payment service, etc., and the one or more servers for each payment processor generally facilitate remote communication therewith to authenticate and/or authorize a payment via a payment gateway server 140. The payment transaction data may be stored in one or more payment database(s) 152 associated with each payment processor.

The one or more payment platform server(s) 160 receives and processes the marketplace and/or onboarding request(s) from a client device 110 associated with an entity, such as a travel provider via a travel provider server 130 (e.g., a travel company connecting to the payment platform to incorporate the latest travel fintech innovations with an aim to improve the payment experience for their clients, i.e., travelers). The one or more payment platform server(s) 160 includes a marketplace instruction set 170 that performs a marketplace protocol according to processes described herein. The one or more payment platform server(s) 160 also includes an onboarding integration instruction set 180 that performs an onboarding integration protocol according to processes described herein. The marketplace instruction set 170 and the onboarding integration instruction set 180 may include a plurality of modules.

The marketplace instruction set 170 includes one or more modules (e.g., API/portal module 172, marketplace search module 174, user interface module 176, database module 178, etc.) that integrate a plurality of payment services and thus require a complex orchestration aspect. The payment marketplace service provides detailed information based on live traffic, an ability to differentiate and expose live traffic but also other information and can restrict information being displayed and capabilities based on current contract requirements. In an exemplary embodiment, the marketplace process for the marketplace instruction set 170 is based on the following steps. First, users (e.g., customers) log into and access a marketplace module (e.g., API/Portal module 172) on the payment management platform via a payment portal (e.g., via user interface module 176). Users can then search for providers based on a series of different criteria: markets, currencies, products, product capabilities, and the like (e.g., via marketplace search module 174). The payment management platform retrieves the partners matching the criteria used from one or more databases, including real-time live data (e.g., via database module 178). The payment management platform then displays the information based on marketplace packages contract agreements. Depending on the information associated with a contract agreement, a partner may be able to access an associated profile and update information (which may then be flagged accordingly), manage push notifications to customers, be available for customers to subscribe to their updates, and be preferably ranked in customers searches. In some implementations of the invention, the data accessed at the one or more databases provides live data to inform a client about payment partner capabilities.

The onboarding integration instruction set 180 includes one or more modules (e.g., API/portal module 182, integration/workflow module 184, user interface module 186, APIs document and certification module 188, etc.) that integrates a plurality of payment services and thus require a complex orchestration aspect in order to provide a complete end-to-end, self-service process flow to get connected to payment management platform. In an exemplary embodiment, the onboarding process for the onboarding integration instruction set 180 is based on one or more of the following steps. First, users (e.g., partners) access an interface (e.g., via user interface module 186) to subscribe to the platform offers, fill products they will power via the partnership, and the like. Then, based on the data filled by the user, the payment management platform may generate different tools for the user to get connected to the payment management platform (e.g., API, scripts, network, etc.) (e.g., via API/portal module 182). The payment management platform allows the user to provide development on the user side following a defined workflow to integrate with the payment management platform (e.g., via integration workflow module 184). Then the payment management platform may display the newly integrated certified partner based on providing certification documentation (e.g., APIs document and certification module 188) under the marketplace module on the payment management platform via a payment portal. For example, the certified partner and its capabilities will then be exposed to customers, so that they can make a conscious decision about whether to contract with this partner or not.

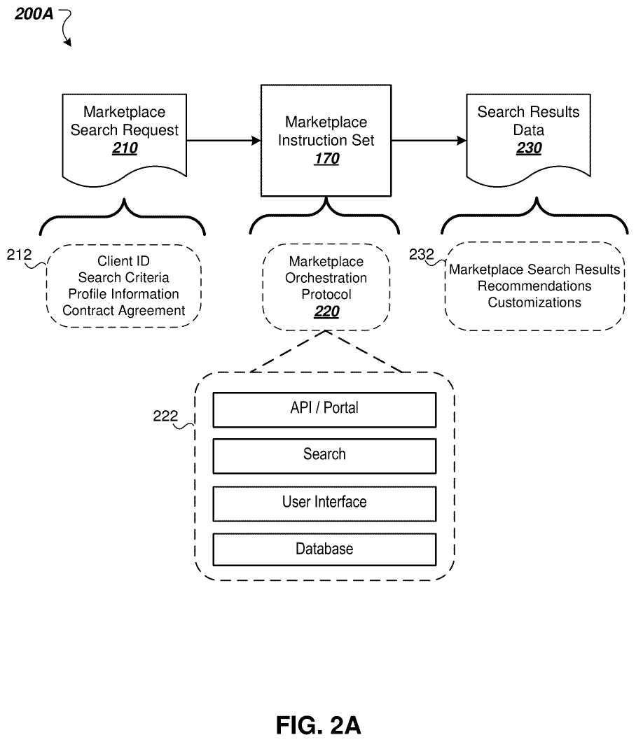

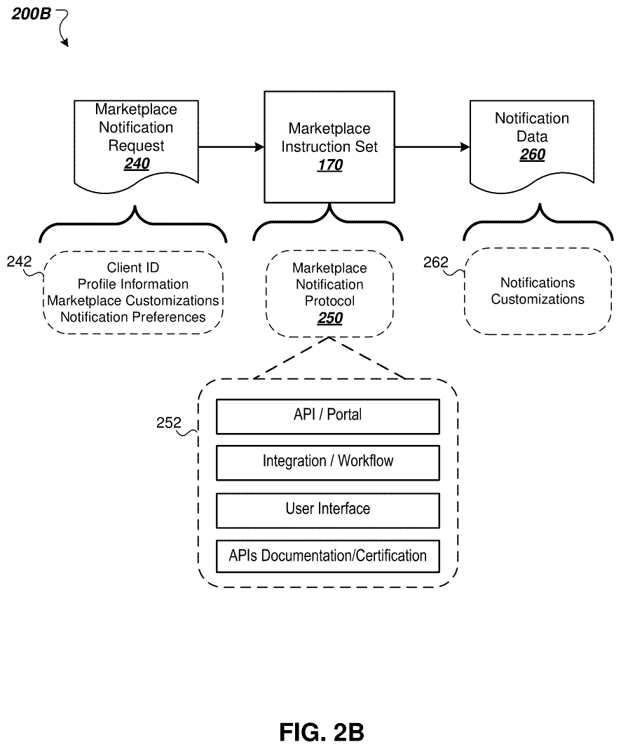

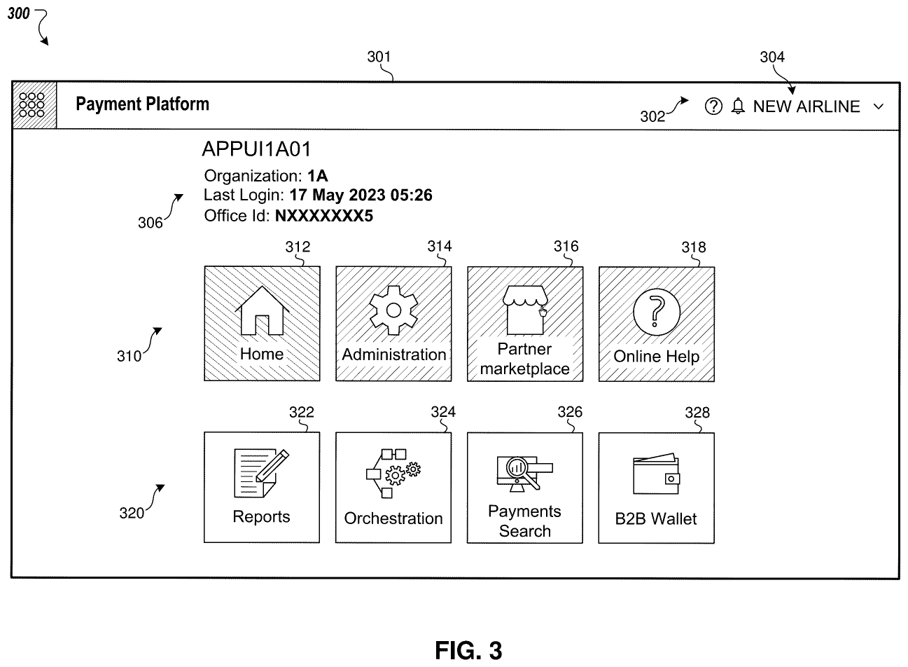

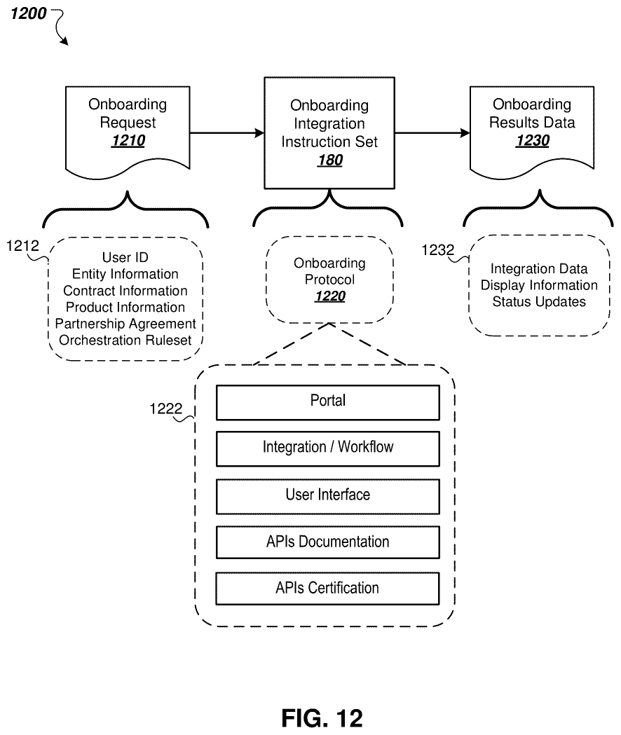

An example routine of implementing a marketplace orchestration and notification process as illustrated in the environment of FIG. 1 is further discussed herein with reference to the example environments of FIGS. 2A and 2B, and the example screenshots of FIGS. 3-10. Furthermore, an example routine of implementing an onboarding integration process as illustrated in the environment of FIG. 1 is further discussed herein with reference to the example environments of FIGS. 12-14.

FIG. 2A illustrates an example marketplace search process based on a marketplace search request, according to embodiments of the invention. In particular, FIG. 2A illustrates an example environment 200A for a marketplace orchestration implementation for determining search results data 230 based on receiving a marketplace search request 210. One objective for the marketplace instruction set 170 is to implement a marketplace orchestration process (e.g., a process service that includes a complex orchestration aspect on front-end side to integrate a plurality of payment services with an ability to differentiate and expose live traffic but also other information and can restrict information being displayed and capabilities based on current contract requirements) utilizing one or more payment platform servers that are in communication with the travel providers, travel reservation systems, and payment processors via a payment platform gateway. For example, the marketplace instruction set 170, stored on one or more payment platform server(s) 160, receives a marketplace search request 210 (e.g., from a merchant device such as a reservation server 120, a travel provider server 130, or the like). The marketplace search request 210 includes search request information 212 (e.g., client ID, search criteria, profile information, contract agreement data, etc.) that is associated with a selected marketplace for a search request.

The marketplace instruction set 170 initiates a marketplace orchestration protocol 220 to generate search results data 230. The search results data 230 may include marketplace search results data 232 such as marketplace search results, recommendations, and/or customizations. The marketplace orchestration protocol 220 includes, for example, one or more modules to perform a plurality of services. For example, an API/portal module (e.g., API/portal module 172) to manage the generation and connection of the API between one or more entities (e.g., travel providers connected to a plurality of payment providers). For example, a provider may integrate a REST API, get connected, get certified, and access its profile, complete their listing, and eventually check performance data, as well as get visibility on products and capabilities available. The marketplace orchestration protocol 220 may further include a marketplace search module (e.g., marketplace search module 174) that provides access to a search engine for providers to perform searches based on a series of different criteria: markets, currencies, products, product capabilities, and the like. The marketplace orchestration protocol 220 may further include a user interface module (e.g., user interface module 176) that provides and/or updates a client interface, such as a GUI, for client devices to access, for example, all of the payment partner data discussed herein. The marketplace orchestration protocol 220 may further include a database module (e.g., database module 178) that provides access to one more databases, which may include live data to inform a client about real time payment partner capabilities.

FIG. 2B illustrates an example marketplace notification process based on a marketplace notification request, according to embodiments of the invention. In particular, FIG. 2B illustrates an example environment 200B for a marketplace orchestration implementation for determining notification data 260 based on receiving a marketplace notification request 240. One objective for the marketplace instruction set 170 is to implement a marketplace notification process (e.g., a process service that includes a complex orchestration aspect on front-end side to provide customized notifications with an ability to differentiate and expose live traffic but also other information and can restrict information being displayed and capabilities based on current contract requirements) utilizing one or more payment platform servers that are in communication with the travel providers, travel reservation systems, and payment processors via a payment platform gateway. For example, the marketplace instruction set 170, stored on one or more payment platform server(s) 160, receives a marketplace notification request 240 (e.g., from a merchant device such as a reservation server 120, a travel provider server 130, or the like). The marketplace notification request 240 may include notification request information 242 (e.g., client ID, profile information, marketplace customizations, notification preferences, etc.) that is associated with a particular client for a notification request.

The marketplace instruction set 170 initiates a marketplace notification protocol 250 to generate notification data 260. The notification data 260 may include notification data 262 such as notifications and/or customizations. The marketplace notification protocol 250 includes, for example, one or more modules to perform a plurality of services. For example, an API/portal module (e.g., API/portal module 172) to manage the generation and connection of the API between one or more entities (e.g., travel providers connected to a plurality of payment providers). For example, a provider may integrate a REST API, get connected, get certified, and access its profile, complete their listing, and eventually check performance data, as well as get visibility on products and capabilities available. The marketplace notification protocol 250 may further include a marketplace integration workflow module (e.g., marketplace search module 184) that provides access to a search engine for providers to perform searches based on a series of different criteria: markets, currencies, products, product capabilities, and the like. The marketplace notification protocol 250 may further include a user interface module (e.g., user interface module 176) that provides and/or updates a client interface, such as a GUI, for client devices to view and access, for example, the notification information discussed herein. The marketplace notification protocol 250 may further include an APIs document and certification module (e.g., APIs document and certification module 188) that controls the data and the display of the data associated with the newly integrated certified partner (e.g., certification documentation), as further discussed herein.

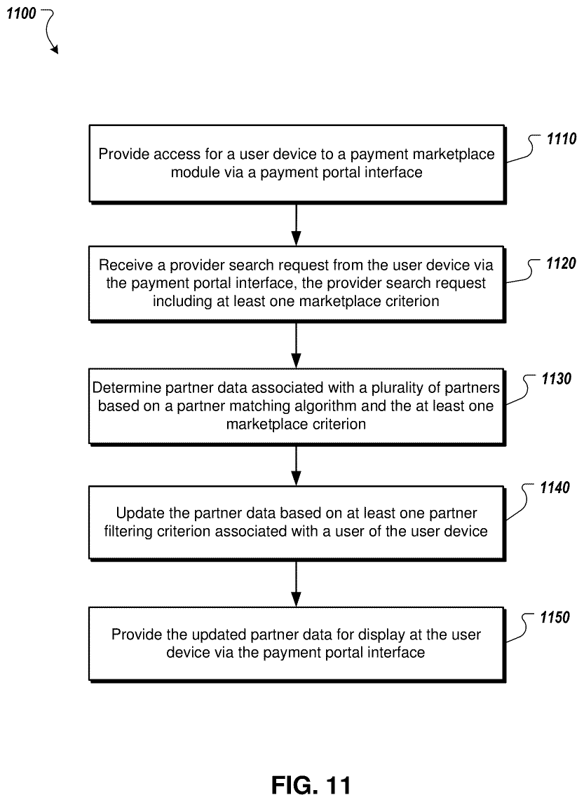

Example illustrations of implementing a marketplace protocol as illustrated in FIGS. 2A and 2B (e.g., user interface screenshots) are further discussed herein with reference to the screenshots of FIGS. 3-10. The actions of the payment platform server(s) 160 utilizing the marketplace instruction set 170 to process the marketplace orchestration protocol 220 and/or the marketplace notification protocol 250 as illustrated in FIGS. 2A and 2B are further described herein with reference to a method flowchart for process 1100 in FIG. 11.

FIG. 3 illustrates an example screenshot 300 for the payment platform via a payment portal interface 301, according to embodiments of the invention. The example screenshot 300 illustrates an example payment platform overview, with access to several tools associated with the marketplace processes discussed herein. The payment portal interface 301 may also be referred to herein as a “marketplace portal.”

As illustrated in example screenshot 300, the interface overview may include an access point toolbar for notifications or webpage support (e.g., toolbar 302), and a drop-down menu (e.g., area 304) for selecting different entities (e.g., airlines) for access to each platform associated a particular entity (e.g., provide access to visibility for all payment partners associated with the particular airline). The interface overview for the payment portal interface 301 further includes the entity information (e.g., area 306), and a list of applications and/or quick links to the key functions associated with the payment platform such as the home applications (e.g., area 310), or direct links to the payment portal tools (e.g., area 320). For example, the home applications may include a home link (e.g., element 312), an admin link (e.g., element 314), partner marketplace link (e.g., element 316), and an online help link (e.g., element 318). The payment portal tools may include a reports link (e.g., element 322), an orchestration link (e.g., element 324), a payments search link (e.g., element 326), and a business-to-business (B2B) wallet link (e.g., element 328).

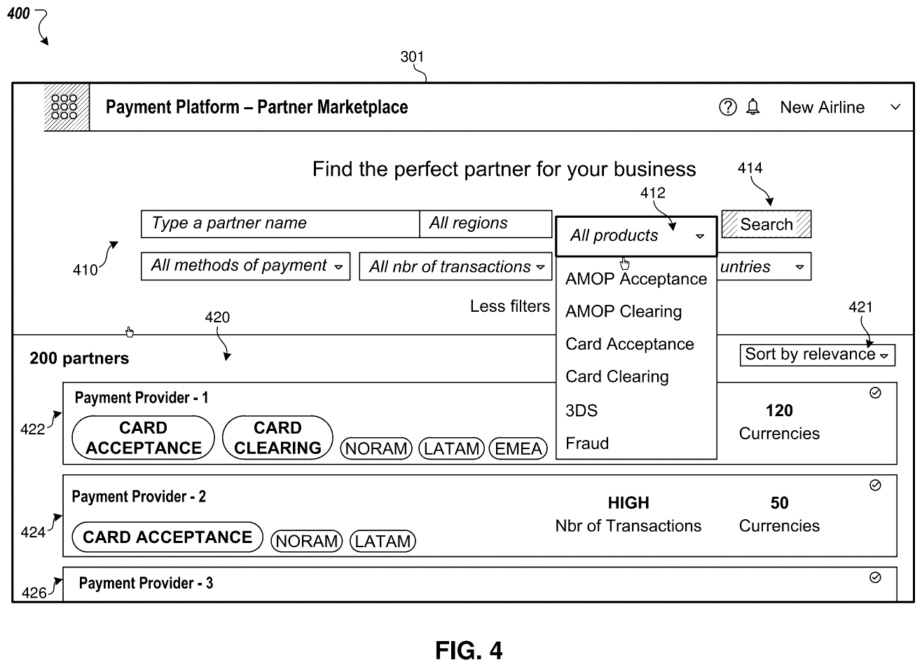

FIG. 4 illustrates an example screenshot 400 for the payment platform via the payment portal interface 301, according to embodiments of the invention. The example screenshot 400 illustrates an example partner marketplace (e.g., after accessing the partner marketplace link-element 316), with access to marketplace search tools (e.g., area 410) and a visualization of the marketplace partners (e.g., area 420). The visualization of the marketplace partners for area 420 may include all of the current available payment partners to be searches, or may be refined based on the marketplace search results associated with a marketplace search.

As illustrated in example screenshot 400, the marketplace search tools at area 410 may include different search parameters (e.g., filters). Users can search for payment providers based on a series of different criteria such as markets, currencies, products, product capabilities, and the like. For example, the search tools at area 410 may include text entry for a specific partner name (or part of a name), a location/region, a method of payment, a number of transactions, and/or a selection of different type of products a payment provider may provide via a drop-down menu (e.g., area 412). A user may enter one search parameter, or any combination of multiple search parameters for each of the different search parameters shown. The user may initiate a marketplace partner search via a selection of the search link 414.

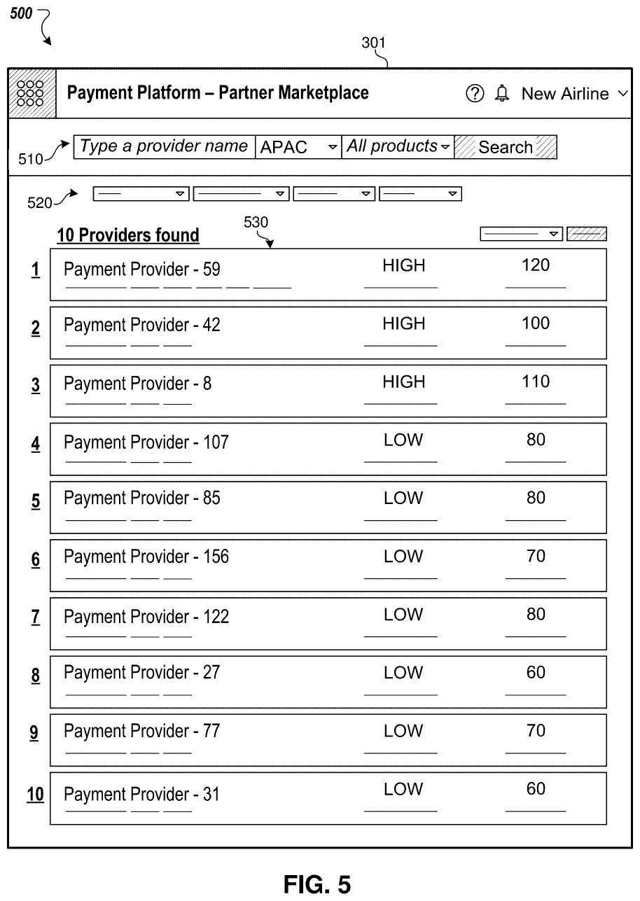

The visualization of the marketplace partners at area 420 provides a list of all the partners prior to an initial search. After a search is performed, area 420 will be updated with a list of all of the selected/searched partners that met the one or more search criteria parameters (e.g., see FIG. 5). For example, as the user scrolls down the web page of the payment portal interface 301, each of the partners shown in area 420 includes a partner overview card. For example, area 422 shows a partner overview card for payment provider-1, area 424 shows a partner overview card for payment provider-2, and area 426 shows a top portion of a partner overview card for payment provider-3. Each partner overview card may include one or more search parameters that were associated with a search such as the different search criteria: markets (e.g., locations/regions), a number of currencies, the types of products offered, a number of transactions, and the like. In some implementations, a partner overview card may include other search parameters such as product capabilities. Additionally, a user can determine to sort the list of partners shown via a drop-down menu (e.g., area 421).

FIG. 5 illustrates an example screenshot 500 for the payment platform via the payment portal interface 301, according to embodiments of the invention. The example screenshot 500 illustrates an example partner marketplace after performing a search (e.g., after selecting the search link-element 414), with access to marketplace search tools (e.g., area 510), additional filter tools of the current search (e.g., area 520), and a visualization of the search results for the marketplace partners that met the one or more search criteria parameters (e.g., area 530). The visualization of the marketplace partners for area 530 as illustrated provides a top ten list for the current search. In some implementations, the data displayed, based on the filtering, may be further sorted by a user. For example, options may be presented to sort the data alphabetically, sort the data based on a number of transactions, update any column of data in a descending or ascending order, sort the data based on a number of currencies in a descending or ascending order, and the like.

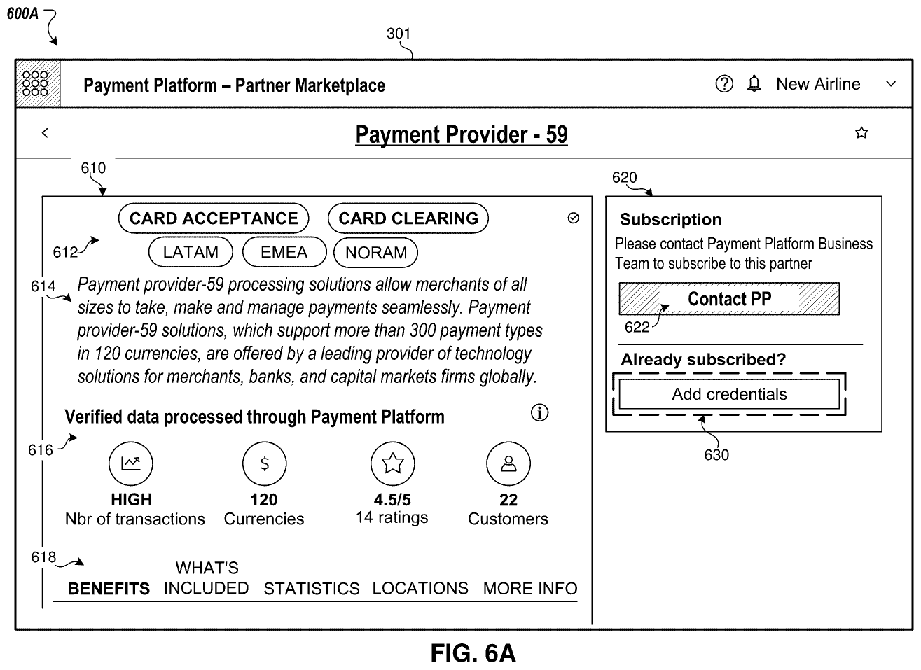

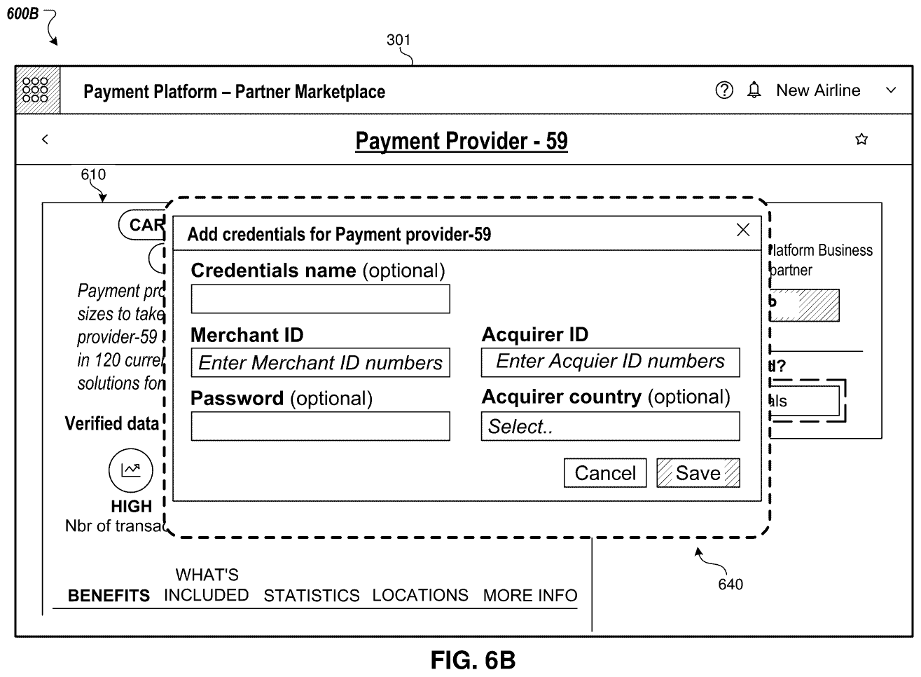

FIGS. 6A, 6B illustrate example screenshots 600A, 600B, respectively, for the payment platform via the payment portal interface 301, according to embodiments of the invention. In particular, the example screenshot 600A illustrates an example partner detail card for payment provider-59 (e.g., after selecting the partner overview card for payment provider-59 in area 530 of FIG. 5). Moreover, the example screenshot 600B illustrates a pop-window (e.g., area 640) for adding credentials to the selected payment provider-59 after a selection of the add credentials link 630 in the example screenshot 600A. FIGS. 6A and 6B provide a client with the ability to visualize where live traffic is going through the payment platform for a given product and/or capability, which product or capability the partner has certified that they can offer to payment platform customers, and which product and capability the partner has declared that they can support additionally.

The example partner detail card for payment provider-59 as illustrated in the example screenshot 600A includes a detail partner section (e.g., area 610) that includes the payment provider's offered products (e.g., area 612), a marketing overview of the provider (e.g., area 614), the verification notification details of the payment provider (e.g., area 616), and links for additional information (e.g., area 618). The example partner detail card for payment provider-59 as illustrated in the example screenshot 600A further includes a subscription section (e.g., area 620) that includes a contact link 622 for contacting the payment platform to request a subscription to the selected payment provider (e.g., payment provider-59), and an already subscribed section (e.g., credentials link 630) that allows a user to add credentials to payment provider that they are already linked to. For example, the pop-up window at area 640 in the example screenshot 600B of FIG. 6B provides the user with the option of adding credentials to a selected payment provider (e.g., payment provider-59).

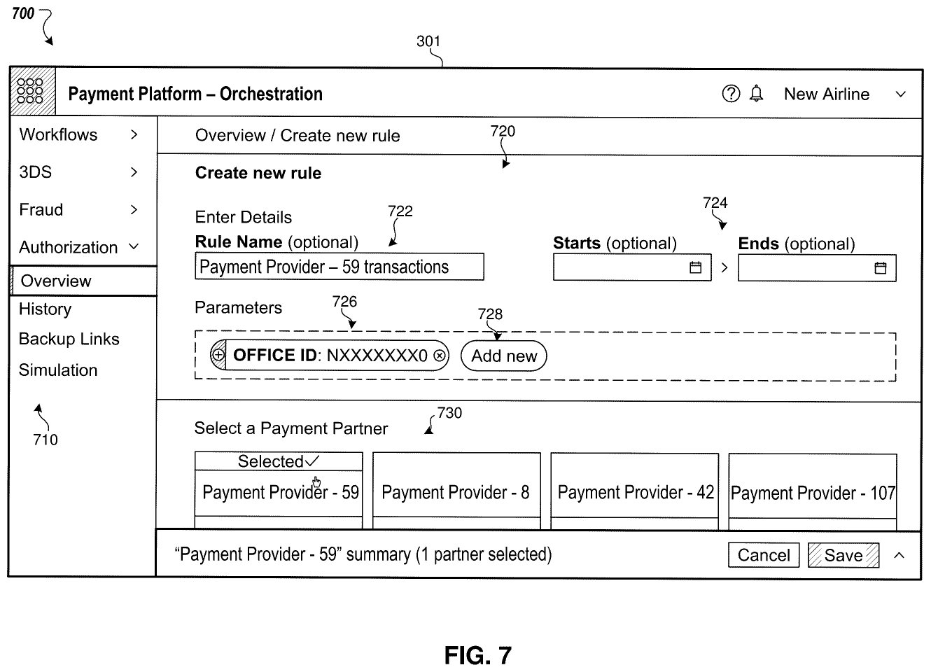

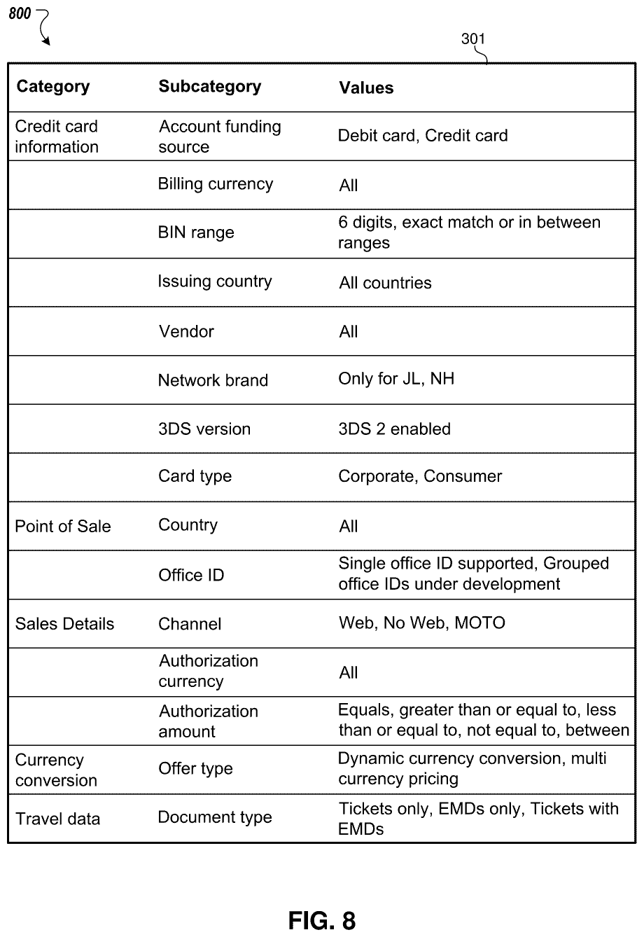

FIG. 7 illustrates an example screenshot 700 for the payment platform via the payment portal interface 301, according to embodiments of the invention. The example screenshot 700 illustrates an example payment platform orchestration for creating a new rule for a selected payment provider (e.g., after selecting the orchestration link-element 324). The example orchestration screenshot includes an overview workflow for selecting different menus/tools (e.g., area 710), a create new rule section (e.g., area 720), and a visualization of the search results for the marketplace partners for selecting a payment provider for the creation of one or more new rules (e.g., area 730). The create new rule section for area 720 as illustrated provides different UI elements for entering details for a new rule including adding a rule name at area 722, creating a date range at area 724, and a list of parameters being used for routing. Additionally, the add new parameter link 728, when selected, provides the user with a new UI window to view and select from a list of parameters as illustrated in FIG. 8.

FIG. 8 illustrates an example screenshot 800 for the payment platform via the payment portal interface 301, according to embodiments of the invention. The example screenshot 800 illustrates an example list of parameters to utilize when creating a new rule (e.g., after selecting the add new parameter link 728 illustrated in the example screenshot 700 of FIG. 7).

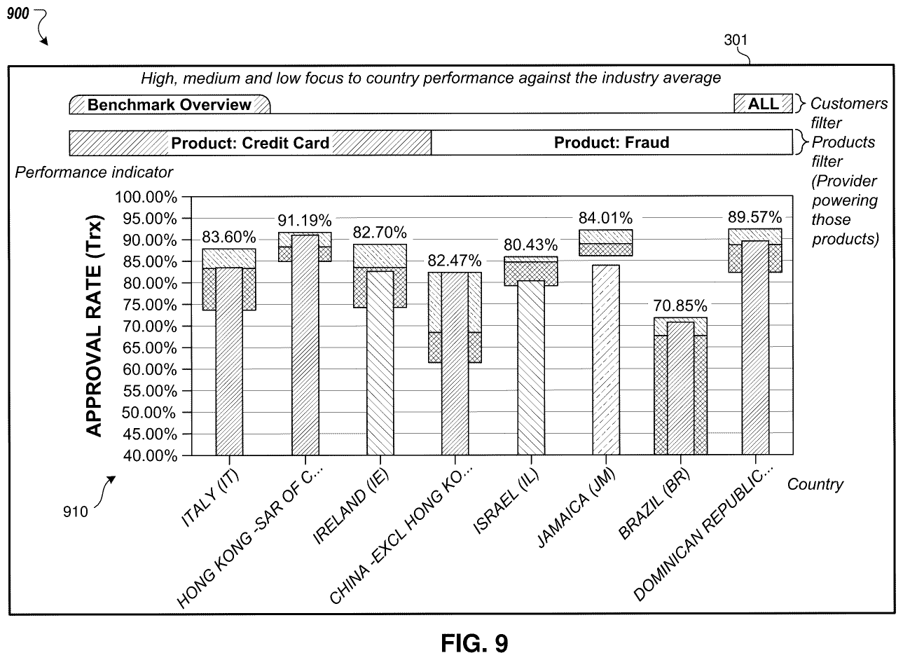

FIG. 9 illustrates an example screenshot 900 for the payment platform via the payment portal interface 301, according to embodiments of the invention. The example screenshot 900 illustrates an example graphical display of a performance indicator, also referred to herein as a performance dashboard. In particular, screenshot 900 illustrates a bar graph 910 for credit card approval ratings for different countries for a selected payment provider. In this particular case for bar graph 910, the credit card authorization's performance of this provider (considering approval rate as the main indicator) is above the average of the industry in Italy, Hong Kong, China mainland, Brazil and Dominican Republic, whereas in Jamaica, 84.01% approval rate is below the average of the industry.

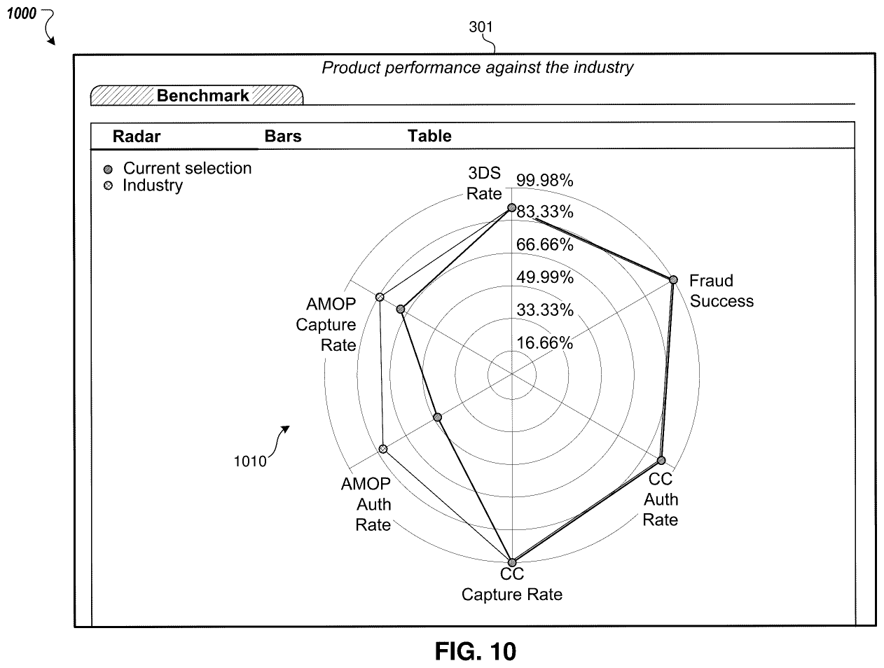

FIG. 10 illustrates an example screenshot 1000 for the payment platform via the payment portal interface 301, according to embodiments of the invention. The example screenshot 1000 illustrates an example graphical display of a performance indicator, also referred to herein as a performance dashboard. In particular, screenshot 1000 illustrates a radar chart 1010 for comparing the different offered products of a selected payment provider to known industry averages. In this particular case for radar chart 1010, this provider should pay attention to the authorization rate of alternative method of payments (AMOP), which is worldwide lower than similar providers working with similar customers (e.g., tier 1 airlines).

Screenshots 900 and 1000 are example visualization for advance performance dashboards for the payment platform described herein. In particular, screenshots 900 and 1000 provide a partner provider descriptive and prescriptive analytics to benchmark themselves against the competition. For example, the advance performance dashboards screenshots 900 and 1000 may provide a visualization of where the partner is positioned compared to the average of the industry, what is its addressable market in the marketplace, in which areas it could improve to capture that whole market and recommendations of actions to improve his performance. Industry data is computed based on the payment platform from live traffic (real-time) and will be shown aggregated, as per data protection requirements.

FIG. 11 illustrates a flowchart of an example process 1100 for implementing and providing a marketplace process, according to embodiments of the invention. Operations of the process 1100 can be implemented, for example, by a system that includes one or more data processing apparatus, such as one or more payment platform server(s) 160 of FIG. 1 utilizing a marketplace instruction set 170 and utilizing one or more protocols (e.g., marketplace orchestration protocol 220, marketplace notification protocol 250, and the like). The process 1100 can also be implemented by instructions stored on computer storage medium, where execution of the instructions by a system that includes a data processing apparatus cause the data processing apparatus to perform the operations of the process 1100.

In some implementations of the invention, the process 1100 integrates a plurality of payment services and requires a complex orchestration aspect. The payment marketplace service may provide detailed information based on live traffic with an ability to differentiate and expose live traffic and can restrict information being displayed and capabilities based on current contract requirements. For example, as illustrated in FIGS. 6A and 6B, the payment platform provides a client with the ability to visualize where live traffic is going through the payment platform for a given product and/or capability, which product or capability the partner has certified that they can offer to payment platform customers, and which product and capability the partner has declared that they can support additionally.

The system, at a device that includes one or more processors, provides access for a user device to a payment marketplace module via a payment portal interface (1110). For example, a payment platform may provide access to a device (e.g., client device 110) via a payment portal interface 301. In some implementations of the invention, the provider search request is received from a travel provider server (e.g., an airline).

In some implementations of the invention, the payment portal interface includes a front-end application program interface (API). In some implementations of the invention, the API is based on a representational state transfer protocol (e.g., REST API).

The system receives a provider search request from the user device via the payment portal interface, the provider search request including at least one marketplace criterion (1120). For example, users can then search for providers based on a series of different criteria: markets, currencies, products, product capabilities, and the like, via the payment portal interface 301, as illustrated in FIGS. 3-8. In some implementations of the invention, the at least one marketplace criterion includes markets, currencies, products, product capabilities, live traffic, or a combination thereof.

The system determines partner data associated with a plurality of partners based on a partner matching algorithm and the at least one marketplace criterion (1130). In some implementations of the invention, determining the partner data associated with the plurality of partners based on the partner matching algorithm and the at least one marketplace criterion includes determining markets, currencies, products, product capabilities, live traffic, or a combination thereof, associated with the plurality of partners.

The system updates the partner data based on at least one partner filtering criterion associated with a user of the user device (1140). For example, as illustrated in the screenshot 500 of FIG. 5, the marketplace orchestration server 160 via the marketplace instruction set 170 may determine how to filter and present the matched payment partners and provides a filtered list of partners based on a current search.

In some implementations of the invention, the at least one partner filtering criterion associated with the user of the user device includes contract agreement data that includes a location, a region, a type of product, live traffic, or a combination thereof. In some implementations of the invention, updating the partner data includes rearranging an order of the plurality of partners based on the contract agreement data. For example, a goal of the payment marketplace service is to first display partners based on a location/region, a type of product, live data, and the like. In some implementations of the invention, providing the updated partner data for display at the user device includes displaying the rearranged order of the plurality of partners based on the contract agreement data (e.g., update the order of partners based on the filter data). For example, the partner data may be updated based on contract agreements, where the goal is to first display partners based on a location such as a region, or a type of product, or display partners relevant for the segment the customer is operating within (e.g., hotel industry).

In some implementations of the invention, the provider search request includes a live traffic transaction option that is selected via the payment portal interface at the user device. In some implementations of the invention, the partner data is updated by utilizing live traffic data from a live traffic database based on the selection of the live traffic transaction option. For example, a live traffic transaction aspect can be exposed to a client as an information to select the provider at the payment interface portal.

The system provides the updated partner data for display at the user device via the payment portal interface (1150). For example, as illustrated in the screenshot 500 of FIG. 5, the marketplace orchestration server 160 via the marketplace instruction set 170 provides a filtered list of partners based on a current search. For example, depending on the information associated with a contract agreement, a partner may be able to access an associated profile and update information (which may then be flagged accordingly), manage push notifications to customers, be available for customers to subscribe to their updates, and be preferably ranked in customers searches.

In some implementations of the invention, the method 1100 may further include receiving, at the payment portal interface, an update request from the user to modify one or more portal elements associated with the user, and updating the one or more portal elements based on the update request. In some implementations of the invention, the one or more portal elements are based on profile information, push notification options, subscriber features, ranking score structures, live traffic transaction options, or a combination thereof. For example, depending on a particular contract agreement, a partner may be able to access an associated profile and update information (which may then be flagged accordingly), manage push notifications to customers, be available for customers to subscribe to their updates, and be preferably ranked in customers searches.

FIG. 12 illustrates an example of a partner self-onboarding integration process based on an onboarding request, according to embodiments of the invention. In particular, FIG. 12 illustrates an example environment 1200 for a partner self-onboarding integration implementation for determining onboarding results data 1230 based on receiving an onboarding request 1210. One objective for the onboarding integration instruction set 180 is to implement a partner self-onboarding integration process (e.g., a process service that includes a complex orchestration aspect on front-end side to integrate a plurality of payment services with an ability to integrate results) utilizing one or more payment platform servers that are in communication with the travel providers, travel reservation systems, and payment processors via a payment platform gateway. For example, the onboarding integration instruction set 180, stored on one or more payment platform server(s) 160, receives an onboarding request 1210 (e.g., from a merchant device such as a reservation server 120, a travel provider server 130, or the like). The onboarding request 1210 includes onboarding request information 1212 (e.g., user ID, entity information, contract information, product information, partnership agreement data, orchestration ruleset data, and the like) that is associated with a selected marketplace for a search request.

The onboarding integration instruction set 180 initiates an onboarding protocol 1220 to generate onboarding results data 1230. The onboarding results data 1230 may include onboarding information 1232 such as integration data, display information, and/or status information. For example, the onboarding protocol 1220 is a multi-step process. Thus, status information may be important to be provided during a current onboarding request, especially if the provider is already integrated and wants to enhance its scope (e.g., addition of new capability in existing product, registration for new product, etc.). In some implementations, several onboarding requests may be in process during a same period of time, thus the status information may be needed to provide a clear status and a way to resume/proceed to a next step.

The onboarding protocol 1220 includes, for example, one or more modules to perform a plurality of services. For example, a portal module (e.g., API/portal module 182) to manage the generation and connection of the API between one or more entities (e.g., travel providers connected to a plurality of payment providers). For example, a provider may integrate a REST API, get connected, get certified, and access its profile, complete their listing, and eventually check performance data, as well as get visibility on products and capabilities available. The onboarding protocol 1220 may further include an integration and workflow module (e.g., integration workflow module 184) that allows the user to provide development on the user side following a defined workflow to integrate with the payment management platform. The onboarding protocol 1220 may further include a user interface module (e.g., user interface module 186) that provides and/or updates a client interface, such as a GUI, for client devices to access, for example, all of the onboarding integration processes and data discussed herein. The onboarding protocol 1220 may further include an APIs documentation and an APIs certification module (e.g., APIs document and certification module 188) that may display the newly integrated certified partner based on providing certification documentation under the marketplace module on the payment management platform via a payment portal.

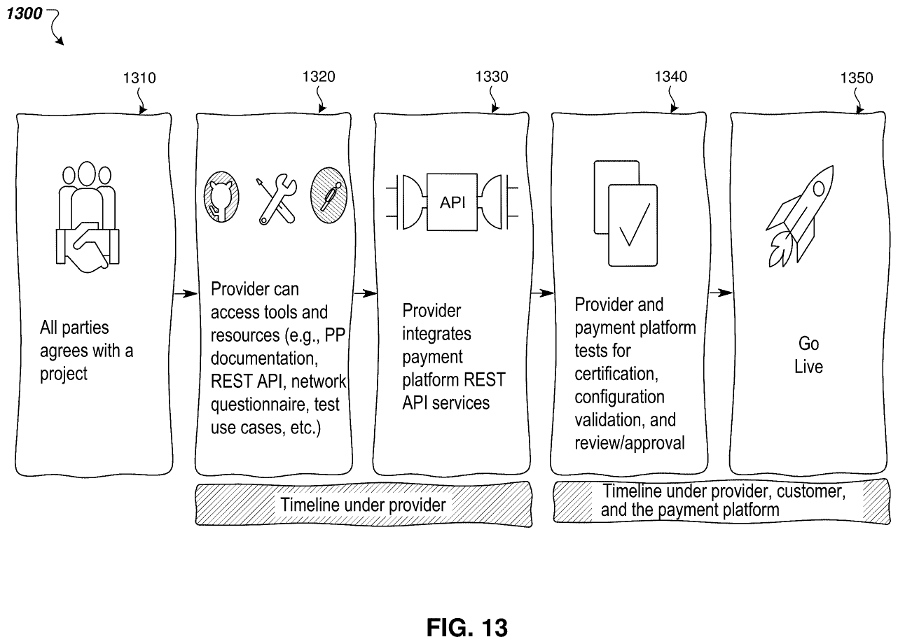

FIG. 13 illustrates an example timeline overview diagram 1300 of a partner self-onboarding integration process based on a contract agreement, according to embodiments of the invention. Operations of the onboarding process associated with the timeline overview diagram 1300 can be implemented, for example, by a system that includes one or more data processing apparatus, such as one or more payment platform server(s) 160 of FIG. 1 utilizing an onboarding integration instruction set 180 and utilizing one or more protocols (e.g., onboarding protocol 1220, and the like). The onboarding process associated with the timeline overview diagram 1300 can also be implemented by instructions stored on computer storage medium, where execution of the instructions by a system that includes a data processing apparatus cause the data processing apparatus to perform the operations of the onboarding process associated with the timeline overview diagram 1300.

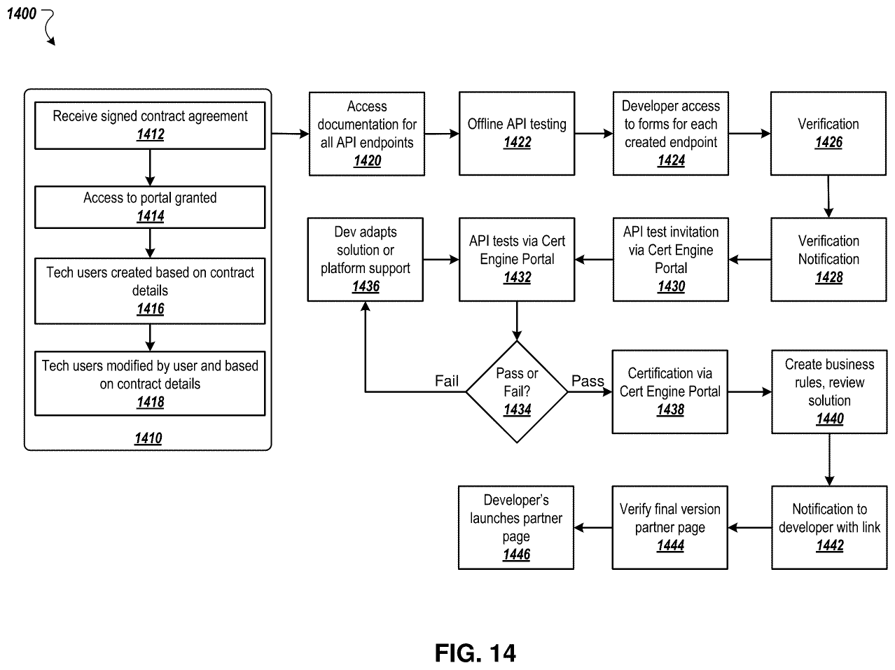

The timeline overview diagram 1300 provides high level visualization of the onboarding integration process. The onboarding process associated with the timeline overview diagram 1300 begins at block 1310 where all parties agree on a project via a contract agreement. The contract agreement, and all terms associated with the contract agreement are uploaded into the payment platform via a user interface (e.g., via interface portal 301). Next, at block 1320, the onboarding integration process presents the provider with a plethora of access and tools and resources to start the integration process. For example, the provider, via an interface to the payment platform, has access to all payment platform documentation, a REST API integration process, network questionnaire, test example use cases, and the like, in order to start integrating to the payment platform. Next, at block 1330, after the provider completes testing, the onboarding integration process continues with the provider integration to the payment platform REST API services. Following the integration to the payment platform REST API services, at block 1340, the provider and the payment platform performs tests for certification, configuration validation, and review and approval processes. Finally, at block 1350, after the certification and configuration is validated, reviewed, and approved, the connected partner is integrated and is live with the payment platform (e.g., can be accessed/searched by other clients looking for integrated payment providers). A more detailed visualization of some of the exemplary steps associated with the onboarding integration process of timeline overview diagram 1300 of FIG. 13 is presented in the exemplary flowchart in FIG. 14.

FIG. 14 illustrates a flowchart of an example process 1400 of a partner self-onboarding integration process based on a contract agreement, according to embodiments of the invention. Operations of the onboarding process 1400 can be implemented, for example, by a system that includes one or more data processing apparatus, such as one or more payment platform server(s) 160 of FIG. 1 utilizing an onboarding integration instruction set 180 and utilizing one or more protocols (e.g., onboarding protocol 1220, and the like). The onboarding process 1400 can also be implemented by instructions stored on computer storage medium, where execution of the instructions by a system that includes a data processing apparatus cause the data processing apparatus to perform the operations of the onboarding process 1400.

The onboarding process 1400 begins at block 1410 as an implementation of a contract agreement process. In particular, the contract agreement process includes receiving a contract agreement (1412), granting access to a payment platform portal to the provider (1414), creating access for technical users associated with the provider based on the contract details (1416), and modifying the access parameters for the technical users based on the contract details (1418). The next blocks 1420-1426 are performed by the client/customer (e.g., by a developer). For example, the provider can access documentation for all API endpoints (1420), perform offline API testing (1422), have access to forms for each created endpoint (1424), and then request verification of the created end points from the payment platform (1426). After verifying the created endpoints, the payment platform provides a verification notification (1428) to the provider, and then sends an API test invitation via a certificate engine portal (1430).

The process 1400 continues where the developer has access to perform API tests via the certificate engine portal (1432). If at the decision block 1432, the API tests fail, then the process 1400 continues at block 1436 where either the developer adapts (e.g., modifies) a current API solution that was tested and/or requests support from the payment platform (e.g., accesses an automatic help desk, calls tech support, etc.). Following block 1436, the updated API solution is then returned to block 1432 to be retested. If at the decision block 1432, the API tests passes, then the process 1400 proceeds to a certification stage processed by the payment platform via the certificate engine portal (1438). After certification, the payment platform then creates business rules associated with the integrated API solution, and reviews/tests the created business rules in a test environment (1440). Following the creation and testing of the business rules, the payment platform provides a notification to the developer that includes a link to the integrated API solution (1442), and the payment platform verifies the final version partner page (1444). The developers can then launch the generated partner page (1446). For example, the partner page may be or may be similar to the partner detail card as illustrated by screenshot 600A of FIG. 6A.

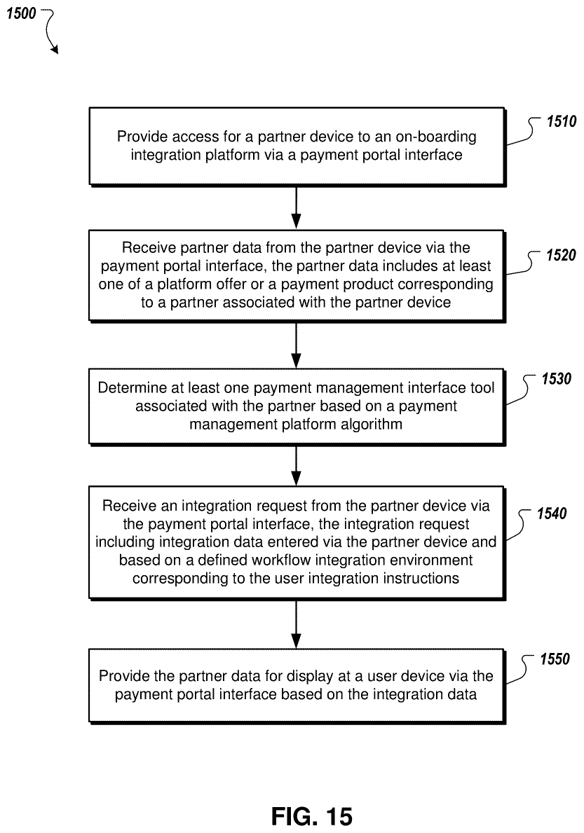

FIG. 15 illustrates a flowchart of an example process 1500 for implementing a partner self-onboarding integration process, according to embodiments of the invention. Operations of the process 1500 can be implemented, for example, by a system that includes one or more data processing apparatus, such as one or more payment platform server(s) 160 of FIG. 1 utilizing an onboarding integration instruction set 180 and utilizing one or more protocols (e.g., onboarding protocol 1220, and the like). The process 1500 can also be implemented by instructions stored on computer storage medium, where execution of the instructions by a system that includes a data processing apparatus cause the data processing apparatus to perform the operations of the process 1500.

In some implementations of the invention, the process 1500 integrates a plurality of payment services and thus require a complex orchestration aspect in order to provide a complete end-to-end, self-service process flow to get connected to payment management platform.

The system provides access for a partner device to an on-boarding integration platform via a payment portal interface (1510). For example, a payment platform may provide access to an on-boarding integration platform (e.g., the payment platform) for a partner device (e.g., client device 110) via a payment portal interface 301.

In some implementations of the invention, the payment portal interface includes a front-end application program interface (API). In some implementations of the invention, the API is based on a representational state transfer protocol (e.g., REST API).

The system receives partner data from the partner device via the payment portal interface, the partner data includes at least one of a platform offer or a payment product corresponding to a partner associated with the partner device (1520). For example, users (e.g., developers access an interface to subscribe to the platform offers and fill products they will power via the partnership.

The system determines at least one payment management interface tool associated with the partner based on a payment management platform algorithm in response to receiving the partner data (1530). For example, the marketplace orchestration server 160 via the onboarding integration instruction set 170 may determine and generate different tools for the user to get connected to the payment management platform such as a REST API, scripts, network, test use cases, etc. based on the data filled by the partner/user.

In some implementations of the invention, determining the at least one payment management interface tool associated with the partner includes performing a verification analysis of the partner data, and in response to verifying the partner data, the process 1500 may further include providing a verification notification via the payment portal interface.

The system receives an integration request from the partner device via the payment portal interface, the integration request including integration data entered via the partner device and based on a defined workflow integration environment corresponding to the user integration instructions (1540). For example, after a provider implements/integrates REST API services, the payment management platform (e.g., payment platform) may allow the user (e.g., a developer) to provide development on the user side following a defined workflow to integrate with the payment management platform, such as the workflow described herein with reference to FIGS. 13 and 14.

In some implementations of the invention, the defined workflow integration environment includes an API test invitation via a certification engine portal. In some implementations of the invention, the certification engine portal is configured to determine whether a user API solution includes a passing mark or a failing mark for a certification test based on the integration data entered via the partner device. In some implementations of the invention, in response to the user API solution including a failing mark, the process 1500 further includes providing failed solution feedback for display at a user device via the payment portal interface. In some implementations of the invention, in response to the user API solution including a passing mark, the process 1500 further includes providing passing solution feedback for display at a user device via the payment portal interface, wherein the passing solution feedback includes a link to download a certification document.

The system provides the partner data for display at a user device via the payment portal interface based on the integration data (1550). For example, the payment management platform (e.g., payment platform) may display the newly integrated certified partner under the marketplace module on the payment management platform via a payment portal.

In some implementations of the invention, the method 1500 may further include receiving, at the payment portal interface, a configuration verification request from the user to verify a business solution entered by the user, and determining whether the business solution entered by the user is publishable on the on-boarding integration platform. In some implementations of the invention, determining whether the business solution entered by the user is publishable on the on-boarding integration platform is based on an analysis performed in a configuration test environment.

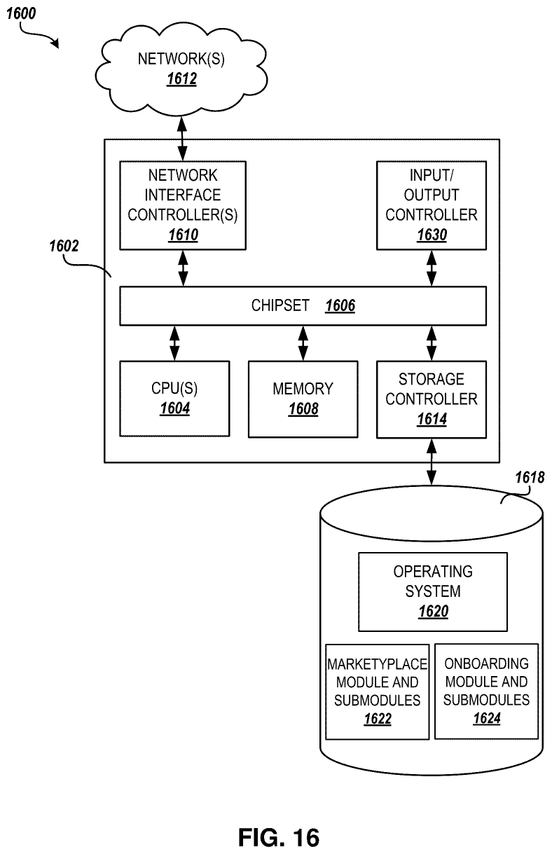

FIG. 16 illustrates an example computer architecture 1600 for a computer 1602 capable of executing the software components described herein for the sending/receiving and processing of tasks. The computer architecture 1600 (also referred to herein as a “server”) shown in FIG. 16 illustrates a server computer, workstation, desktop computer, laptop, a server operating in a cloud environment, or other computing device, and may be utilized to execute any aspects of the software components presented herein described as executing on a host server, or other computing platform. The computer 1602 preferably includes a baseboard, or “motherboard,” which is a printed circuit board to which a multitude of components or devices may be connected by way of a system bus or other electrical communication paths. In one illustrative embodiment, one or more central processing units (CPUs) 1604 operate in conjunction with a chipset 1606. The CPUs 1604 can be programmable processors that perform arithmetic and logical operations necessary for the operation of the computer 1602.

The CPUs 1604 preferably perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, or the like.

The chipset 1606 provides an interface between the CPUs 1604 and the remainder of the components and devices on the baseboard. The chipset 1606 may provide an interface to a memory 1608. The memory 1608 may include a random-access memory (RAM) used as the main memory in the computer 1602. The memory 1608 may further include a computer-readable storage medium such as a read-only memory (ROM) or non-volatile RAM (NVRAM) for storing basic routines that that help to startup the computer 1602 and to transfer information between the various components and devices. The ROM or NVRAM may also store other software components necessary for the operation of the computer 1602 in accordance with the embodiments described herein.

According to various embodiments, the computer 1602 may operate in a networked environment using logical connections to remote computing devices through one or more networks 1612, a local-area network (LAN), a wide-area network (WAN), the Internet, or any other networking topology known in the art that connects the computer 1602 to the devices and other remote computers. The chipset 1606 includes functionality for providing network connectivity through one or more network interface controllers (NICs) 1610, such as a gigabit Ethernet adapter. For example, the NIC 1610 may be capable of connecting the computer 1602 to other computer devices in the utility provider's systems. It should be appreciated that any number of NICs 1610 may be present in the computer 1602, connecting the computer to other types of networks and remote computer systems beyond those described herein.

The computer 1602 may be connected to at least one mass storage device 1618 that provides non-volatile storage for the computer 1602. The mass storage device 1618 may store system programs, application programs, other program modules, and data, which are described in greater detail herein. The mass storage device 1618 may be connected to the computer 1602 through a storage controller 1614 connected to the chipset 1606. The mass storage device 1618 may consist of one or more physical storage units. The storage controller 1614 may interface with the physical storage units through a serial attached SCSI (SAS) interface, a serial advanced technology attachment (SATA) interface, a fiber channel (FC) interface, or other standard interface for physically connecting and transferring data between computers and physical storage devices.

The computer 1602 may store data on the mass storage device 1618 by transforming the physical state of the physical storage units to reflect the information being stored. The specific transformation of physical state may depend on various factors, in different embodiments of the invention of this description. Examples of such factors may include, but are not limited to, the technology used to implement the physical storage units, whether the mass storage device 1618 is characterized as primary or secondary storage, or the like. For example, the computer 1602 may store information to the mass storage device 1618 by issuing instructions through the storage controller 1614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1602 may further read information from the mass storage device 1618 by detecting the physical states or characteristics of one or more particular locations within the physical storage units.

The mass storage device 1618 may store an operating system 1620 utilized to control the operation of the computer 1602. According to some embodiments, the operating system includes the LINUX operating system. According to another embodiment, the operating system includes the WINDOWS® SERVER operating system from MICROSOFT Corporation of Redmond, Wash. According to further embodiments, the operating system may include the UNIX or SOLARIS operating systems. It should be appreciated that other operating systems may also be utilized. The mass storage device 1618 may store other system or application programs and data utilized by the computer 1602, such as the marketplace orchestration module and submodules 1622, which may include the marketplace instruction set 170 and the one or more submodules included therein, according to embodiments described herein. For example, the marketplace module and submodules 1622 may include submodules such as the API/portal module 172, the marketplace search module 174, the user interface module 176, the database module 178, and/or other modules discussed herein or may otherwise be appropriate. The mass storage device 1618 may further store other system or application programs and data utilized by the computer 1602, such as the onboarding module and submodules 1624, which may include the onboarding integration instruction set 180 and the one or more submodules included therein, according to embodiments described herein. For example, the onboarding module and submodules 1624 may include submodules such as the API/portal module 182, the integration workflow module 184, the user interface module 186, the APIs documentation and certification module 188, and/or other modules discussed herein or may otherwise be appropriate. Other system or application programs and data utilized by the computer 1602 may be provided as well (e.g., a security module, a fraud module, a validation module, etc.).

In some embodiments, the mass storage device 1618 may be encoded with computer-executable instructions that, when loaded into the computer 1602, transforms the computer 1602 from being a general-purpose computing system into a special-purpose computer capable of implementing the embodiments described herein. These computer-executable instructions transform the computer 1602 by specifying how the CPUs 1604 transition between states, as described above. According to some embodiments, from the payment platform server(s) 160 perspective, the mass storage device 1618 stores computer-executable instructions that, when executed by the computer 1602, perform portions of the process 1100, for implementing a marketplace orchestration system, and/or perform portions of the process 1500, for implementing an onboarding integration system, as described herein. In further embodiments, the computer 1602 may have access to other computer-readable storage medium in addition to or as an alternative to the mass storage device 1618.

The computer 1602 may also include an input/output controller 1630 for receiving and processing input from a number of input devices, such as a keyboard, a mouse, a touchpad, a touch screen, an electronic stylus, or other type of input device. Similarly, the input/output controller 1630 may provide output to a display device, such as a computer monitor, a flat-panel display, a digital projector, a printer, a plotter, or other type of output device. It will be appreciated that the computer 1602 may not include all of the components shown in FIG. 16, may include other components that are not explicitly shown in FIG. 16, or may utilize an architecture completely different than that shown in FIG. 16.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A method comprising:
at a device comprising one or more processors:
providing, via a payment portal interface, access for a user device to a payment marketplace module;
receiving a provider search request from the user device via the payment portal interface, wherein the provider search request comprises at least one marketplace criterion;
in response to receiving the provider search request, determining, based on a partner matching algorithm and the at least one marketplace criterion, partner data associated with a plurality of partners;
updating the partner data based on at least one partner filtering criterion associated with a user of the user device; and
providing the updated partner data for display at the user device via the payment portal interface.

2. The method of claim 1, wherein the at least one marketplace criterion comprises markets, currencies, products, product capabilities, live traffic, or a combination thereof.

3. The method of claim 1, wherein determining the partner data associated with the plurality of partners based on the partner matching algorithm and the at least one marketplace criterion comprises determining markets, currencies, products, product capabilities, live traffic, or a combination thereof, associated with the plurality of partners.

4. The method of claim 1, wherein the at least one partner filtering criterion associated with the user of the user device comprises contract agreement data that includes a location, a region, a type of product, or a combination thereof.

5. The method of claim 4, wherein updating the partner data comprises rearranging an order of the plurality of partners based on the contract agreement data.

6. The method of claim 5, wherein providing the updated partner data for display at the user device comprises displaying the rearranged order of the plurality of partners based on the contract agreement data.

7. The method of claim 1, wherein the provider search request comprises a live traffic transaction option that is selected via the payment portal interface at the user device.

8. The method of claim 7, wherein the partner data is updated by utilizing live traffic data from a live traffic database based on the selection of the live traffic transaction option.

9. The method of claim 1, further comprising:
receiving, at the payment portal interface, an update request from the user to modify one or more portal elements associated with the user; and
updating the one or more portal elements based on the update request.

10. The method of claim 9, wherein the one or more portal elements are based on profile information, push notification options, subscriber features, ranking score structures, live traffic transaction options, or a combination thereof.

11. The method of claim 1, wherein the payment portal interface comprises a front-end application program interface (API).

12. The method of claim 11, wherein the API is based on a representational state transfer protocol.

13. The method of claim 1, wherein the provider search request is received from a travel provider server.

14. A device comprising:
a non-transitory computer-readable storage medium; and
one or more processors coupled to the non-transitory computer-readable storage medium, wherein the non-transitory computer-readable storage medium comprises program instructions that, when executed by the one or more processors, cause the one or more processors to:
provide, via a payment portal interface, access for a user device to a payment marketplace module;
receive a provider search request from the user device via the payment portal interface, wherein the provider search request comprises at least one marketplace criterion;
in response to receiving the provider search request, determine, based on a partner matching algorithm and the at least one marketplace criterion, partner data associated with a plurality of partners;
update the partner data based on at least one partner filtering criterion associated with a user of the user device; and
provide the updated partner data for display at the user device via the payment portal interface.

15. The device of claim 14, wherein the at least one marketplace criterion comprises markets, currencies, products, product capabilities, live traffic, or a combination thereof.

16. The device of claim 14, wherein determining the partner data associated with the plurality of partners based on the partner matching algorithm and the at least one marketplace criterion comprises determining markets, currencies, products, product capabilities, live traffic, or a combination thereof, associated with the plurality of partners.

17. The device of claim 14, wherein the at least one partner filtering criterion associated with the user of the user device comprises contract agreement data that includes a location, a region, a type of product, or a combination thereof.

18. The device of claim 17, wherein updating the partner data comprises rearranging an order of the plurality of partners based on the contract agreement data.

19. The device of claim 18, wherein providing the updated partner data for display at the user device comprises displaying the rearranged order of the plurality of partners based on the contract agreement data.

20. The device of claim 14, wherein the provider search request comprises a live traffic transaction option that is selected via the payment portal interface at the user device.

21. The device of claim 20, wherein the partner data is updated by utilizing live traffic data from a live traffic database based on the selection of the live traffic transaction option.

22. The device of claim 14, wherein the program instructions, when executed by the one or more processors, further cause the one or more processors to:
receive, at the payment portal interface, an update request from the user to modify one or more portal elements associated with the user; and
update the one or more portal elements based on the update request.

23. The device of claim 22, wherein the one or more portal elements are based on profile information, push notification options, subscriber features, ranking score structures, live traffic transaction options, or a combination thereof.

24. The device of claim 14, wherein the payment portal interface comprises a front-end application program interface (API).

25. The device of claim 24, wherein the API is based on a representational state transfer protocol.

26. The device of claim 14, wherein the provider search request is received from a travel provider server.

27-39 (canceled)
